(19) United States
(12) Patent Application Publication
(10) Pub. No.: US 2024/0260763 A1
(43) Pub. Date: Aug. 8, 2024

(54) RIB AND MANUFACTURING PROCESS THEREOF AND INFLATABLE PRODUCT

(71) Applicant: ZHEJIANG NATURAL OUTDOOR GOODS INC., Taizhou City (CN)

(72) Inventors: Yonghui Xia, Taizhou City (CN); Zhijian Ma, Taizhou City (CN); Mengzhi Zhou, Taizhou City (CN)

(21) Appl. No.: 18/304,907

(22) Filed: Apr. 21, 2023

(30) Foreign Application Priority Data
Feb. 7, 2023 (CN) 2023101367591

(51) Int. Cl. A47C 27/08; D03D 1/02; D03D 13/00

(52) U.S. Cl. CPC A47C 27/087; A47C 27/081; D03D 1/02; D03D 13/008; D10B 2503/00

(57) ABSTRACT

A rib, a manufacturing process thereof, and an inflatable product, which relate to the technical field of inflatable products, including a main-body rib and an auxiliary rib; the main-body rib and the auxiliary rib are integrally formed through weaving woven threads, an included angle is formed between the auxiliary rib and the main-body rib, two ends of the main-body rib are configured to be welding-connected with a cover cloth and a base cloth of the inflatable product, respectively, one end of the auxiliary rib extending out of the main-body rib is configured to connect with the side wall.

### CROSS-REFERENCE TO RELATED APPLICATION

The present disclosure claims priority to Chinese Patent Application No. 2023101367591 filed on Feb. 7, 2023 with the Chinese Patent Office, and entitled “Rib and Manufacturing Process Thereof and Inflatable Product”, the contents of which are incorporated herein by reference in entirety.

### TECHNICAL FIELD

The present disclosure relates to the technical field of inflatable products, and more particularly, to a rib and a manufacturing process thereof and an inflatable product.

### BACKGROUND ART

The so-called inflatable product refers to a product with a specific shape that is formed by firstly providing an inflatable cavity enclosed by a plurality of peripheral pieces, and then inflating the inflatable cavity. The inflatable products, which have been widely used for their advantages of being comfortable, easy to carry, and soft, include a plurality of products such as inflatable beds, inflatable sofas, inflatable toys, inflatable castles, etc. Among those inflatable products, most of the peripheral pieces thereof are usually made of soft materials; therefore, the inflatable products will form a sphere, such as a balloon, during inflation.

In the prior art, in order to avoid the inflatable product becoming a sphere after inflation, people usually arrange ribs inside the inflatable cavity, and the ribs are connected with the peripheral pieces and are capable of providing supporting and shaping functions. Therefore, the inflatable product can form a specific shape according to positions of the ribs arranged inside the inflatable cavity, a number of ribs, and an enclosing shape of the peripheral pieces.

However, for the high inflatable products, the ribs can only be used as a connection structure of a cover cloth and a base cloth. Due to a side wall is used as the side-wall structure of the inflatable products, the cover cloth and the base cloth are welded to the side wall of an air bed, and there is no transverse force on the side wall. The welding and inflating of the side wall and the cover cloth will increase side arc, causing a protrusion of the side wall, resulting in the instability of the inflatable products.

### SUMMARY

The object of the present disclosure is to provide a rib (reinforcement rib) and a manufacturing process thereof and an inflatable product, to alleviate the existing technical problems that a cover cloth, a base cloth, and a side wall of an air bed are welded, there is no transverse force applied on the side wall, and a side arc will increase due to an inflation of the side wall and the cover cloth, leading to a protrusion of the side wall and resulting in a technical problem of instability of the inflatable products.

A rib provided by the present disclosure is configured to be installed at a position of an inflatable product close to a side wall, including: a main-body rib and an auxiliary rib;
the main-body rib and the auxiliary rib are integrally formed through weaving woven threads, an included angle is formed between the auxiliary rib and the main-body rib, two ends of the main-body rib are configured to be welding-connected with a cover cloth and a base cloth of the inflatable product, respectively, and one end of the auxiliary rib extending out of the main-body rib is configured to connect with the side wall, so as to limit an arc of the side wall through the cover cloth and the base cloth.

In an embodiment of the present disclosure, two auxiliary ribs are provided;
the two auxiliary ribs are located on the same side of the main-body rib, and the two auxiliary ribs are arranged symmetrically with a center line of the main-body rib, respectively, the main-body rib is arranged as being a height corresponding to a height of the side wall, and the two auxiliary ribs are connected with the side wall, respectively, so as to make a relatively balanced force on the side wall formed.

In an embodiment of the present disclosure, the main-body rib includes a first adhesive layer, and a first dense weaving region and a first pattern weaving region that are integrally formed, wherein a weaving density of the first pattern weaving region is lower than that of the first dense weaving region; and
the first dense weaving region is provided as two segments, the two segments of the first dense weaving region are clamped at both ends of the first pattern weaving region, the first pattern weaving region is corresponding to the height of the main-body rib, the first adhesive layer is connected with the first dense weaving region, and the two segments of the first dense weaving region are welding-connected with the cover cloth and the base cloth through the first adhesive layer, respectively.

In an embodiment of the present disclosure, the auxiliary rib includes a second adhesive layer, a second dense weaving region, and a second pattern weaving region, wherein a weaving density of the second pattern weaving region is lower than that of the second dense weaving region; and
the second pattern weaving region is provided by performing extension from interweaving points of the first dense weaving region and the first pattern weaving region, the second pattern weaving region and the first dense weaving region are integrally formed by weaving, and the second pattern weaving region and the first pattern weaving region are arranged at an included angle; the second dense weaving region and the second pattern weaving region are integrally formed by weaving away from one end of the first dense weaving region, the second adhesive layer is connected with the second dense weaving region, and the second dense weaving region is welding-connected with the side wall through the second adhesive layer.

A manufacturing process based on the mentioned rib provided by the present disclosure includes the following steps:
weaving the first segment of the first dense weaving region according to a preset size, weaving the first segment of the first dense weaving region by dividing it into two segmental surfaces, so as to weave the first pattern weaving region with a same width at both ends along ends of the first dense weaving region, wherein, the weaving density of the first pattern weaving region is lower than that of the first dense weaving region;
combining ends of the two segments of the first pattern weaving region to weave the second segment of the first dense weaving region;
cutting any segment of the first pattern weaving region of at a center thereof, hot-pressing half of a welding film on a cutting edge, and hot-pressing the other half of the welding film on the side wall; and
applying local glue to a surface of each segment of the first dense weaving region.

The manufacturing process based on the mentioned rib provided by the present disclosure includes the following steps:
weaving the first segment of the first dense weaving region according to the preset size, weaving the first segment of the first dense weaving region by dividing it into two segmental surfaces, so as to weave the first pattern weaving region and the first segment of the second pattern weaving region along the ends of the first dense weaving region, wherein, the weaving density of the first pattern weaving region is lower than that of the first dense weaving region;
completing weaving of the first segment of the second pattern weaving region according to the preset size, weaving the first segment of the second dense weaving region at the end of the completed first segment of the second pattern weaving region, completing weaving of the first segment of the second dense weaving region according to the preset size, wherein, the weaving density of the second pattern weaving region is lower than that of the second dense weaving region;
completing weaving of the first pattern weaving region according to the preset size, weaving the end of the first pattern weaving region that is completely woven by dividing it into two segmental surfaces, so as to weave the second segment of the first dense weaving region and the second segment of the second pattern weaving region along the first pattern weaving region respectively;
completing weaving of the second segment of the first dense weaving region and the second segment of the second pattern weaving region according to the preset size, weaving the second segment of the second dense weaving region at the end of the second pattern weaving region that is completely woven, and completing weaving of the second segment of the second dense weaving region according to the preset size; and
performing local gluing to a surfaces of each of the segments of the first dense weaving region and each of the segments of the second dense weaving region.

In an embodiment of the present disclosure, the following steps can be further included:
dividing the first segment of first dense weaving region into a plurality of segmental surfaces to perform weaving, weaving the first pattern weaving region and a plurality of segments of the second pattern weaving region along the end of the first dense weaving region, respectively, and weaving the second dense weaving region corresponding to the end of each segment of the second pattern weaving region; and
dividing the end of the first pattern weaving region that is completely woven into a plurality of segmental surfaces to perform weaving, weaving the second segment the first dense weaving region and a plurality of segments of the second pattern weaving region along the first pattern weaving region, respectively, weaving the second dense weaving region corresponding to the end of each of the segments of the second pattern weaving region, wherein, the second pattern weaving region divided from the end of the first dense weaving region and the second pattern weaving region divided from the end of the first pattern weaving region are symmetrically arranged.

The manufacturing process based on the mentioned rib provided by the present disclosure includes the following steps:
weaving the first segment of the first dense weaving, the first pattern weaving region, and the second segment of the first dense weaving region in turn according to the preset size, wherein the weaving density of the first pattern weaving region is lower than that of the first dense weaving region;
weaving the second pattern weaving region and the second dense weaving region in turn according to the preset size, wherein the weaving density of the second pattern weaving region is lower than that of the second dense weaving region; and
performing welded or sewing-fixed connecting between two second pattern weaving regions and the first segment of the first dense weaving region and the second segment of the first dense weaving region in symmetrical positions, respectively.

An inflatable product provided by the present disclosure includes a cover cloth, a base cloth, a side wall, and the mentioned rib;
wherein the side wall is arranged circumferentially along an edge of the cover cloth, the side wall is connected with the cover cloth and the base cloth, respectively, and an inflatable space for accommodating the rib is formed between the cover cloth, the side wall, and the base cloth form;
the main-body rib is located between the cover cloth and the base cloth, adhesive layers are arranged at intervals along both sides of surfaces of the main-body rib, and the main-body rib is connected, through the adhesive layers on both sides, with the cover cloth and the base cloth by a hot melt process;
the auxiliary rib is located at a side close to the side wall, one end of the auxiliary rib extending out of the main-body rib and the side wall face toward both ends of the cover cloth and the base cloth to connect respectively, so as to limit an arc of the side wall through the cover cloth and the base cloth.

The rib provided by the present disclosure is configured to be installed at a position on the inflatable product close to the side wall, including: a main-body rib and an auxiliary rib; the main-body rib and the auxiliary rib are integrally formed through weaving woven threads, an included angle is formed between the auxiliary rib and the main-body rib, two ends of the main-body rib are configured to be welding-connected with a cover cloth and a base cloth of the inflatable product, respectively, and one end of the auxiliary rib extending out of the main-body rib is configured to connect with the side wall; by arranging ribs at a position on the inflatable product close to the side wall, on the basis of using the main-body rib to fix the cover cloth and the base cloth by welding, and using the auxiliary rib with the oblique extension to connect with the side wall, a stretching applied force can be provided to the side wall by the cover cloth, the base cloth, and the main-body rib, so as to limit the extended arc of the side wall after inflation, thus alleviating the existing technical problems in the prior art that when the cover cloth, the base cloth, and the main-body rib are welded to the sidewall, there is no transverse force applied on the side wall, and the side arc will increase after inflation of the side wall and the cover cloth, causing the protrusion of the side wall, and resulting in the instability of the inflatable products.

### BRIEF DESCRIPTION OF DRAWINGS

In order to more clearly explain the technical solution in the embodiments of the present disclosure or the prior art, the following content will be used to briefly introduce the drawings required to be used in the embodiments or the prior art, it is obviously that the following drawings only illustrate some embodiments of the present disclosure, and for ordinary people skilled in this filed, other relevant drawings according to these drawings without paying for any creative work can be obtained.

FIG. 1 shows a schematic structural diagram of a rib with weaving density provided by an embodiment of the present disclosure;

FIG. 2 shows a schematic structural diagram of the rib in which an auxiliary rib is divided into two segments provided by an embodiment of the present disclosure;

FIG. 3 shows a schematic structural diagram of the rib in which the auxiliary rib has a welding film provided by an embodiment of the present disclosure;

FIG. 4 shows a schematic structural diagram of the rib installed inside an inflatable product provided by an embodiment of the present disclosure;

FIG. 5 shows a schematic structural diagram of another manner of the rib installed inside the inflatable product provided by an embodiment of the present disclosure;

FIG. 6 shows a schematic structural diagram of the rib in which the auxiliary rib are bonded after a separate weaving;

FIG. 7 shows a schematic structural diagram of the rib in which the auxiliary rib is formed as a plurality of segmental surfaces provided by an embodiment of the present disclosure; and

FIG. 8 is a schematic structural diagram of the rib installed inside the inflatable product provided by the embodiment of FIG. 7.

Reference signs: 100-main-body rib; 101-first dense weaving region; 102-first pattern weaving region; 200-auxiliary rib; 201-second dense weaving region; 202-second pattern weaving region; 203-welding film; 300-cover cloth; 400-base cloth; 500-side wall.

### DETAILED DESCRIPTION OF EMBODIMENTS

The following will clearly and completely describe the technical solutions of the present disclosure in combination with the embodiments. Obviously, the described embodiments are part of the embodiments of the present disclosure, not all of the embodiments. Based on the embodiments in the present disclosure, all other embodiments obtained by ordinary skilled in this field without paying for creative work belong to the scope of protection of the present disclosure.

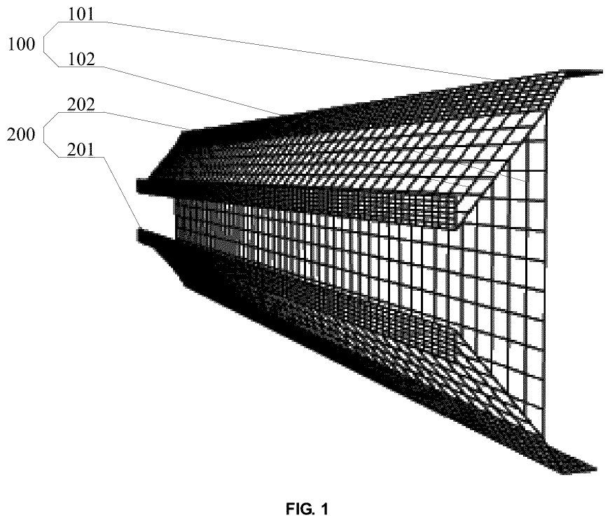

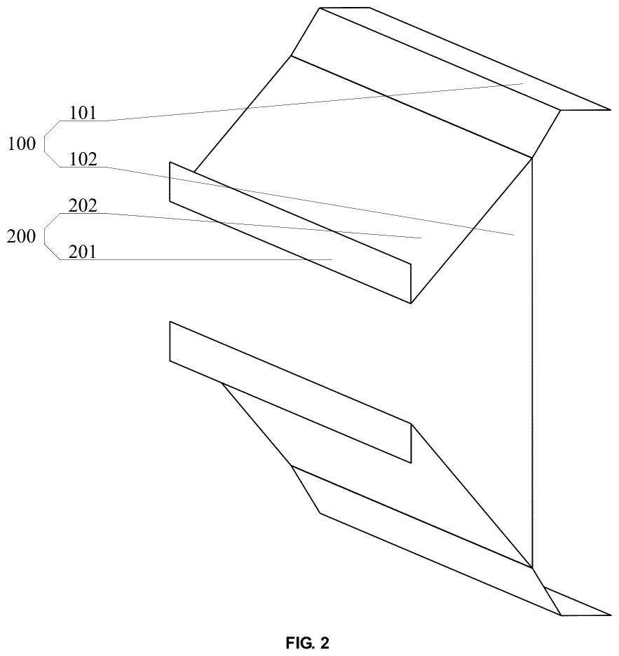

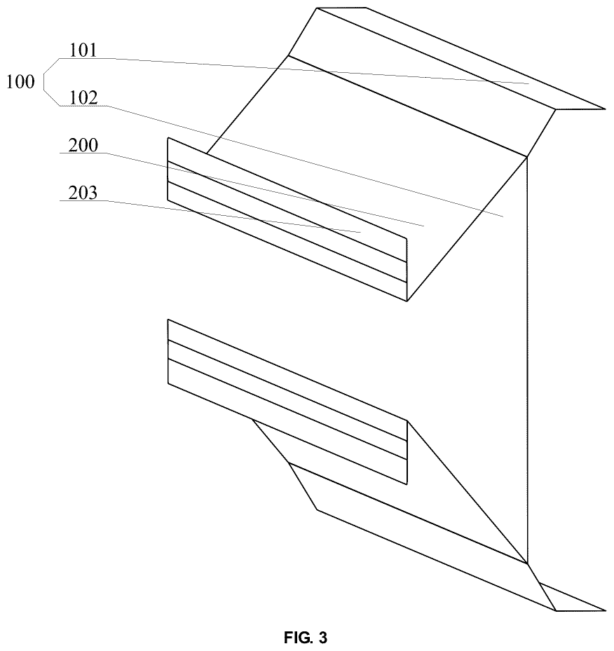

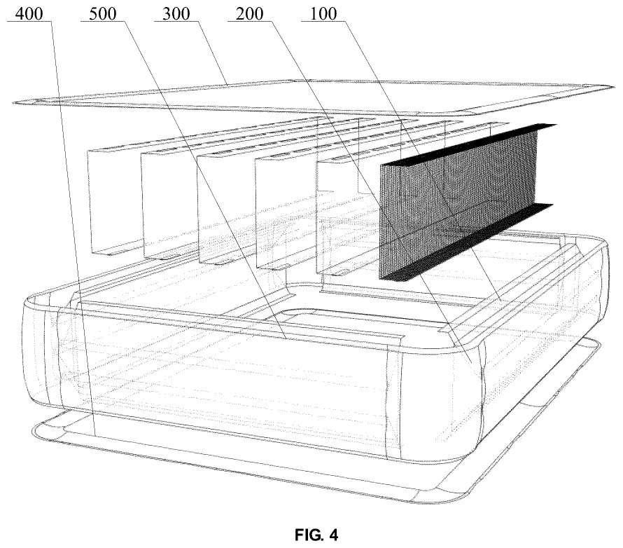

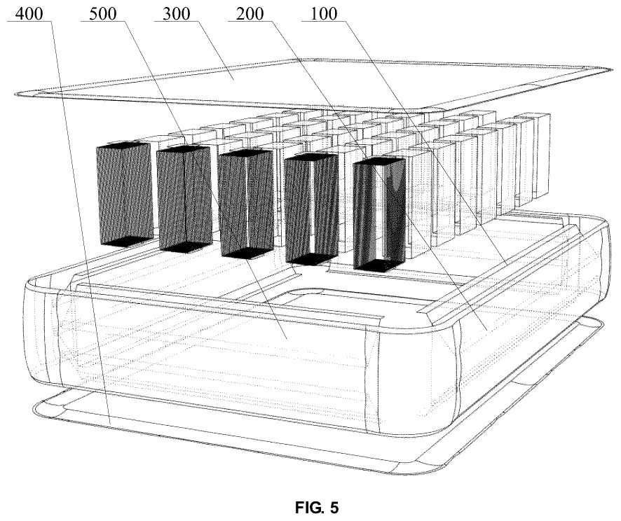

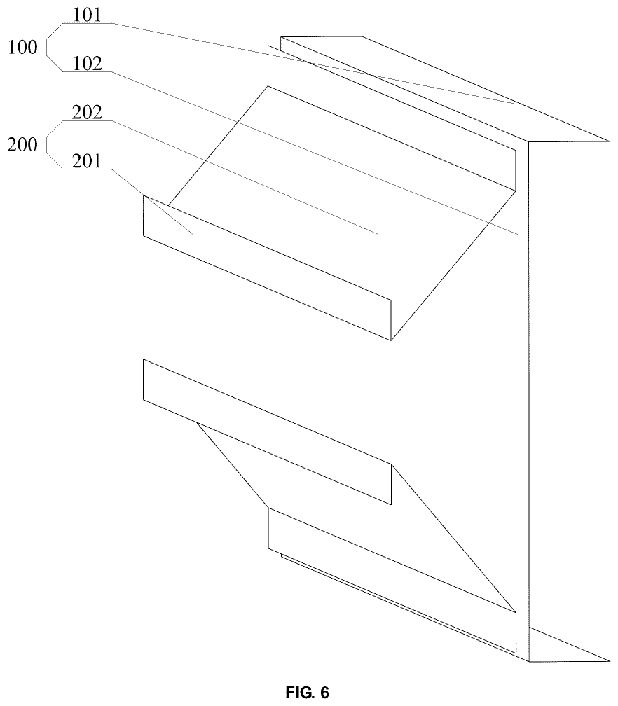

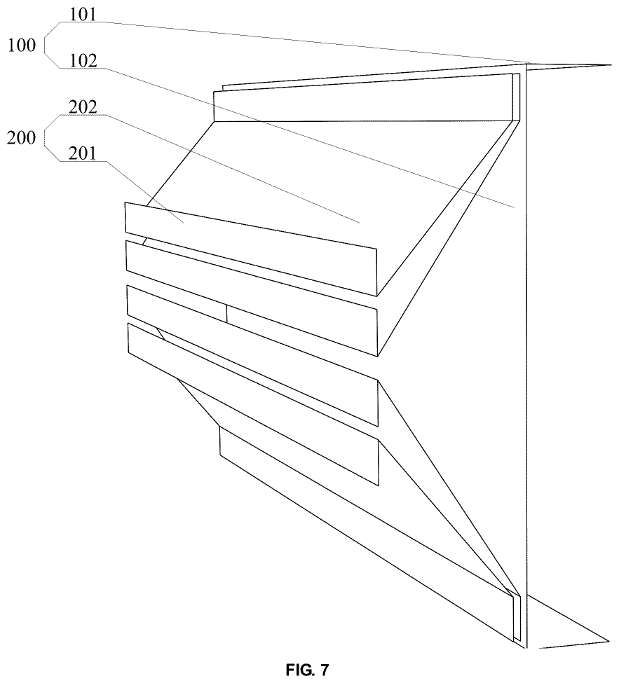

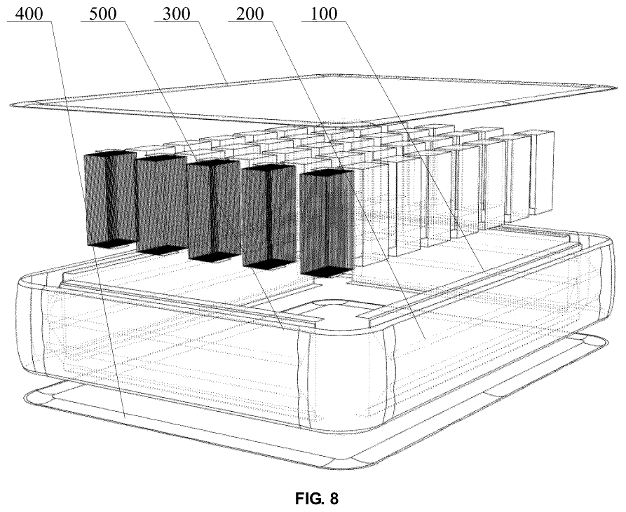

As shown in FIG. 1 to FIG. 8, a rib provided by the present embodiment is configured to be installed at a position on an inflatable product close to a side wall 500, including: a main-body rib 100 and an auxiliary rib 200; the main-body rib 100 and the auxiliary rib 200 are integrally formed through weaving woven threads, wherein an included angle is formed between the auxiliary rib 200 and the main-body rib 100, two ends of the main-body rib 100 are configured to be welding-connected with a cover cloth 300 and a base cloth 400 of the inflatable product, respectively, one end of the auxiliary rib 200 extending out of the main-body rib 100 is configured to connect with the side wall 500, so as to limit an arc of the side wall 500 through the cover cloth 300 and the base cloth 400.

It should be noted that the ribs provided in the present embodiment can be arranged circumferentially along the interior of the side wall 500, and the ribs can apply, based on making the cover cloth 300 and the base cloth 400 fixed, a force on the side wall 500, so as to ensure the arc of the side wall 500 after inflation. Specifically, the main-body rib 100 and the auxiliary rib 200 are integrally formed through the weaving woven threads, wherein the main-body rib 100 can be located between the cover cloth 300 and the base cloth 400 in a vertical arrangement, the auxiliary rib 200 and the main-body rib 100 are arranged obliquely, and two ends of the auxiliary rib 200 are connected with the main-body rib 100 and the side wall, respectively, that is, the auxiliary rib 200 can apply an oblique force on the side wall. By using the auxiliary rib 200, an arc extension force of inflation of the side wall can be transferred to the main-body rib 100, and the inflated cover cloth 300 and base cloth 400, so as to limit the arc extended by the inflation of the side wall 500 and ensure the stability of the inflatable product.

The ribs provided by the present embodiment are configured to be installed at the position on the inflatable product close to the side wall 500, including: the main-body rib 100 and the auxiliary rib 200; the main-body rib 100 and the auxiliary rib 200 are integrally formed through the weaving woven threads, wherein an included angle is formed between the auxiliary rib 200 and the main-body rib 100, the two ends of the main-body rib 100 are configured to be welding-connected with the cover cloth 300 and the base cloth 400 of the inflatable product, respectively, one end of the auxiliary rib 200 extending out of the main-body rib 100 is configured to connect with the side wall 500. By arranging ribs at the position on the inflatable product close to the side wall 500, and on the basis of using the main-body rib 100 to fix the cover cloth 300 and the base cloth 400 by welding, the auxiliary rib 200 with an oblique extension is used to connect with the side wall 500, so that the cover cloth 300, the base cloth 400, and the main-body rib 100 provide a stretching applied force to the side wall 500, so as to limit the extended arc of the side wall 500 after inflation, which alleviates the existing technical problems in the prior art that when the cover cloth 300 and the base cloth 400 are welded to the side wall 500 of an air bed, there is no transverse force applied on the side wall 500, and the side arc will increase due to inflation of the side wall 500 and the cover cloth 300, causing the protrusion of the side wall 500, resulting in the instability of the inflatable products.

On the basis of the above embodiment, further, in an embodiment of the present disclosure, two auxiliary ribs 200 are provided, wherein the two auxiliary ribs 200 are located on the same side of the main-body rib 100, the two auxiliary ribs 200 are arranged symmetrically with the center line of the main-body rib 100, respectively, the main-body rib 100 is arranged as being a height corresponding to a height of the side wall 500, and the two auxiliary ribs 200 are connected with the side wall 500, respectively, so as to make a relatively balanced force on the side wall 500 formed.

In the present embodiment, the two auxiliary ribs 200 are arranged symmetrically along the center line of the main-body rib 100, that is, after the two ends of the main-body rib 100 are fixed with the cover cloth 300 and the base cloth 400 by welding, respectively, the two obliquely extended auxiliary ribs 200 are connected with two symmetrical positions of the side wall 500, respectively, so that the applied force on the side wall 500 can be better balanced to the positions of the cover cloth 400 and the base cloth 400, ensuring the balance of the applied force on the side wall 500. Optionally, oblique directions of the two auxiliary ribs 200 may be in an oblique way in which they are relatively close to each other.

In an embodiment of the present disclosure, the main-body rib 100 includes a first adhesive layer, and a first dense weaving region 101 and a first pattern weaving region 102 which are integrally formed by weaving. The weaving density of the first pattern weaving region 102 is lower than that of the first dense weaving region 101. The first dense weaving region 101 is provided as two segments, and the two segments of the first dense weaving region 101 are clamped at both ends of the first pattern weaving region 102. The first pattern weaving region 102 is corresponding to the height of the main-body rib 100, the first adhesive layer is connected with the first dense weaving region 101, and the two segments of the first dense weaving region 101 are welding-connected with the cover cloth 300 and the base cloth 400 through the first adhesive layer, respectively.

In the present embodiment, the first dense weaving region 101 and the first pattern weaving region 102 are woven in turn according to the preset size. The raw fabric can be made of cotton, polyester, or nylon, etc. In the weaving stage, the first dense weaving region 101 and the first pattern weaving region 102 are woven according to the required sizes of the product with the corresponding width. In addition, the first dense weaving region 101 serves as a local gluing position of the end of the main-body rib 100, that is, the first dense weaving region 101 is connected with the cover cloth 300 and the base cloth 400, respectively. The weaving density of the first pattern weaving region 102 is lower than that of the first dense weaving region 101, that is, the first pattern weaving region 102 serves as the height side wall position of the main-body rib 100, and by means of low weaving density, the weight of the main-body rib 100 can be reduced and the ventilation can be improved on the basis of ensuring the strength and toughness of the main-body rib 100. Further, by means of applying local glue on the surface of the first dense weaving region 101, the local glue is dried to form the first adhesive layer, and form the main-body rib 100. When the main-body rib 100 is required to be installed in the inflatable product, it only needs to use the position of the first adhesive layer for the welding-connection.

In an embodiment of the present disclosure, the auxiliary rib 200 includes a second adhesive layer, a second dense weaving region 201, and a second pattern weaving region 202, wherein the weaving density of the second pattern weaving region 202 is lower than that of the second dense weaving region 201. The second pattern weaving region 202 is provided by perform extension from the interweaving points of the first dense weaving region 101 and the first pattern weaving region 102. The second pattern weaving region 202 and the first dense weaving region 101 are integrally formed by weaving. The second pattern weaving region 202 and the first pattern weaving region 102 are arranged at an included angle. The second dense weaving region 201 and one end of the first dense weaving region 101 away from the second pattern weaving region 202 are integrally formed by weaving. The second adhesive layer is connected with the second dense weaving region 201, and the second dense weaving region 201 is welding-connected with the side wall 500 through the second adhesive layer.

In the present embodiment, the second dense weaving region 201 and the second pattern weaving region 202 are woven in turn according to the preset size. The raw fabric can be made of cotton, polyester, or nylon, etc. In the weaving stage, the second dense weaving region 201 and the second pattern weaving region 202 are woven according to the required sizes of the product with the corresponding width. In addition, the second dense weaving region 201 serves as a local gluing position of the end of the auxiliary rib 200, the second pattern weaving region 202 and the first dense weaving region 101 can be integrally formed by weaving, and a connection can be formed between the second dense weaving region 201 and the side wall 500. The weaving density of the second pattern weaving region 202 is lower than that of the second dense weaving region 201, that is, the second pattern weaving region 202 serves as the extension side wall position of the auxiliary rib 200 and the side wall 500. By means of low weaving density, the weight of the auxiliary rib 200 can be reduced and the ventilation can be improved on the basis of ensuring the strength and toughness of the auxiliary rib 200. Further, by means of applying local glue on the surface of the second dense weaving region 201, the local glue is dried to form a second adhesive layer, and form the auxiliary rib 200. When the main-body rib 100 is required to be installed in the inflatable product, it only needs to use the position of the second adhesive layer for the welding-connection.

It should be noted that there may be a variety of manufacturing processes for the ribs provided in the present embodiment. A manufacturing process based on the ribs provided in the present embodiment includes the following steps: weaving the first segment of the first dense weaving region 101 according to the preset size, wherein the first segment of the first dense weaving region 101 is divided it into two segmental surfaces to be woven, so as to weave the first pattern weaving region 102 and the first segment of the second pattern weaving region 202 along the end of the first dense weaving region 101, wherein, the weaving density of the first pattern weaving region 102 is lower than that of the first dense weaving region 101; completing weaving of the first segment of the second pattern weaving region 202 according to the preset size, weaving the first segment of the second dense weaving region 201 at the end of the completed first segment of the second pattern weaving region 202, and completing weaving of the first segment of second dense weaving region 201 according to the preset size, wherein, the weaving density of the second pattern weaving region 202 is lower than that of the second dense weaving region 201; completing weaving of the first pattern weaving region 102 according to the preset size, and weaving the end of the completed first pattern weaving region 102 by dividing it into two segmental surfaces, so as to weave the second segment of the first dense weaving region 101 and the second segment of the second pattern weaving region 202 along the first pattern weaving region 102 respectively; completing weaving of the second segment of the first dense weaving region 101 and the second segment of the second pattern weaving region 202 according to the preset size, weaving the second segment of the second dense weaving region 201 at the end of the completed second segment of the second pattern weaving region 202, and completing the weaving of the second segment of the second dense weaving region 201 according to the preset size; and applying local glue on the surfaces of each segment of the first dense weaving region 101 and each segment of the second dense weaving region 201.

In the present embodiment, as for weaving the rib by dividing it into two segments, the first dense weaving region 101 of the main-body rib 100 is taken as the starting point, and the end of the first dense weaving region 101 is used as the fabric welding surface. The width of the fabric welding surface can be determined according to the pattern of the surface. The interweaving points of the fabric welding surface and the first pattern weaving region 102 are taken as the first branch line, and the first pattern weaving region 102 and the second pattern weaving region 202 is woven and formed respectively based on the first branch line. Herein, the warp and weft densities of the first pattern weaving region 102 and the second pattern weaving region 202 can be different. The second dense weaving region 201 is continued to be woven at the end of the second pattern weaving region 202 to complete the weaving and forming of one auxiliary rib 200. The end of the completed first pattern weaving region 102 is taken as the second branch line, and the first dense weaving region 101 and the second pattern weaving region 202 are woven and formed respectively based on the second branch line, that is, the weaving and forming of the two segments of the first dense weaving region 101 and the main-body rib 100 clamping the middle first pattern weaving region 102 are complete. Finally, the second dense weaving region 201 is continued to be woven at the end of the second pattern weaving region 202 to complete the weaving and forming of another auxiliary rib 200, and finally, forming the weaving lines of the rib of one main-body rib 100 and two auxiliary ribs 200 by weaving.

Optionally, the weaving formation of the first dense weaving region 101, the first pattern weaving region 102, the second dense weaving region 201, and the second pattern weaving region 202 can adopt a manner that the weft yarns are arranged in parallel, and the warp yarns are woven and formed with the weft yarns in a manner of sequentially bent in a V-shaped. Herein, the woven edge can be formed by turning the weft yarns around the outer warp yarns, and return it to the other side. Such woven edge has wear-resistance because the returning weft yarns lock the outer warp yarns.

Optionally, the connection between the main-body rib 100 and the auxiliary rib 200 can be in other fixing manner, such as forming two segments of the first dense weaving region 101 by weaving, and weaving and forming a pattern weaving region between the two segments of the first dense weaving region 101, to form the main-body rib 100; and weaving and forming the second dense weaving region 201 and the second pattern weaving region 202, to form the auxiliary rib 200, performing a connecting between the second pattern weaving region 202 of two auxiliary ribs 200 and two segments of the first dense weaving region 101 in symmetrical positions by welding or sewing-fixing, that is, the main-body rib 100 and the auxiliary rib 200 are formed by weaving separately, and the ribs are formed by means of welding or sewing.

In the present embodiment, according to the size of the welding point set by the inflatable product, gluing two groups of corresponding patterns in the first dense weaving region 101 or the second dense weaving region 201, that is, each of the first dense weaving regions 101 or the second dense weaving regions 201 is provided with two groups of local gluing, which are arranged symmetrically by the center line of the first dense weaving region 101 or the second dense weaving region 201. It can be orderly distributed by using the two groups of gluing points, the shapes can be regular shapes or according to the mold, and the gluing width can be different. That is, the structures and shapes of the gluing points can be set according to the reference of convenient operation in the manufacturing process. The local gluing may include local point gluing, local line gluing, local surface gluing, local casting, or local filming.

Optionally, the local gluing can be performed by means of using a mold to simultaneously glue by gluing point, or it can also be arranged symmetrically on the ribs by means of local casting respectively. The adhesive materials for local gluing may also have a variety of choices, such as: Thermoplastic Elastomer (TPE), Thermoplastic polyurethanes (TPU), Thermo-Plastic-Rubber material (TPR), Thermoplastic Vulcanizate (TPV), Polyvinyl chloride (PVC), Thermoplastic polyolefin (TPO), Polyvinyl chloride thermoplastic elastomer (TPVC), phenyl vinyl ether (TPVE), EthyleneVinylAcetate (EVA), etc., e.g., the local gluing can be performed by using TPU or PVC for local gluing or local filming.

In an embodiment of the present disclosure, it also includes the following steps: dividing the first segment of the first dense weaving region 101 into a plurality of segmental surfaces to perform weaving, weaving the first pattern weaving region 102 and a plurality of segments of the second pattern weaving region 202 along the end of the first dense weaving region 101, respectively, and weaving a corresponding second dense weaving region 201 at the end of each of the segments of the second pattern weaving region 202; dividing the end of the completed first pattern weaving region 102 into plurality of segmental surfaces to perform weaving, weaving the second segment of the first dense weaving region 101 and a plurality of segments of the second pattern weaving region 202 along the first pattern weaving region 102, respectively, and weaving a corresponding second dense weaving region 201 at the end of each of the segments of the second pattern weaving region 202, wherein the second pattern weaving region 202 divided from the end of the first dense weaving region 101 and the second pattern weaving region 202 divided from the first pattern weaving region 102 are arranged symmetrically.

In the present embodiment, the auxiliary ribs 200 can be arranged as multiple, that is, it can be divided by the center line of the main-body rib 100, and there can be two, three, or four etc. auxiliary ribs 200 arranged in the half range of the side wall 500 close to the cover cloth 300. Similarly, there can be two, three, or four etc. auxiliary ribs 200 can be arranged symmetrically in the half range of the side wall 500 close to the base cloth 400. An even number of auxiliary ribs 200 is used to fix the interior of the side wall 500 by symmetrical force, so that the side wall 500 is provided with a plurality of action points, ensuring the uniformity of the applied force on the side wall 500, so as to better ensure the stability of the side wall 500.

In the present embodiment, as for the auxiliary rib 200, when the rib is woven by a plurality of segmental surfaces, each auxiliary rib 200 includes a segment of the second pattern weaving region 202 and a segment of the second dense weaving region 201, that is, taking the first dense weaving region 101 of the main-body rib 100 as the starting point, and taking the interweaving points of the fabric welding surface and the first pattern weaving region 102 as the first branch line, separately weave and form the first pattern weaving region 102 based on the first branch line, individually weave and form a plurality of the segments of the second pattern weaving region 202 at the same time, wherein a plurality of the segments of the second pattern weaving region 202 are extended along different oblique directions, continue weaving the second dense weaving region 201 at the end of each of the segments of the second pattern weaving region 202, and complete the weaving formation of a plurality of the auxiliary ribs 200 in the half range of the center line of the main-body rib 100. Taking the end of the completed first pattern weaving region 102 as the second branch line, separately weave and form the first dense weaving region 101 based on the second branch line, that is, complete the weaving formation of two segments of the first dense weaving region 101 and the main-body rib 100 that clamps the first pattern weaving region 102 in the middle, a plurality of the segments of the second pattern weaving region 202 are formed by individually weaving at the same time, complete the symmetrical arrangement of a plurality of the segments of the second pattern weaving region 202, continue weaving each of the segments of the second dense weaving region 201 at the end of the second pattern weaving region 202, complete the weaving formation of a plurality of the auxiliary ribs 200 in the other half range of the center line of the main-body rib 100, and finally, complete the weaving formation of the ribs of one main-body rib 100 and a plurality of auxiliary ribs 200.

A manufacturing process based on the mentioned provided by the present embodiment includes the following steps: weaving the first segment of the first dense weaving region 101 according to the preset size, dividing the first segment of the first dense weaving region 101 into two segmental surfaces to perform weaving, and weaving the first pattern weaving region 102 with the same end width along the end of the first dense weaving region 101, wherein the density of the first pattern weaving region 102 is lower than that of the first dense weaving region 101; combining the ends of the two segments of the first pattern weaving region 102 to weave the second segment of the first dense weaving region 101; cutting any segment of the first pattern weaving region 102 at the center, hot pressing half of a welding film 203 at a cutting edge, and hot pressing the other half of the welding film 203 on the side wall 500; performing local gluing to the surface of each segment of the first dense weaving region 101.

In the present embodiment, as the manufacturing manner of weaving the rib by dividing it into two segments, the second dense weaving region 201 is no longer woven for the auxiliary rib 200, that is, the first dense weaving region 101 of the main-body rib 100 is taken as the starting point, and the end of the first dense weaving region 101 is used as the fabric welding surface, wherein the width of the fabric welding surface can be determined according to the pattern of the surface. The interweaving points of the fabric welding surface and the first pattern weaving region 102 are taken as the first branch line, and two first pattern weaving region 102 of the same width is woven based on the first branch line, wherein he warp and weft densities of the two first pattern weaving regions 102 can be different. The ends of the first pattern weaving region 102 are combined to weave the first dense weaving region 101. At this time, either of the two first pattern weaving regions 102 is cut along the center line to form two identical second pattern weaving regions 202. At this time, half of the welding film 203 is hot-pressed along the cutting edge, and the other half of the welding film 203 is hot-pressed on the side wall 500 of the inflatable bed, so as to complete the fixing of the auxiliary rib 200.

Optionally, the welding film 203 is a double-sided weldable film, which can be TPU or PVC.

It should be noted that the main-body rib 100 provided in this embodiment is a C-shaped rib, and the manufacturing process for the C-shaped rib is: two segments of the first dense weaving region 101 and a segment of the first pattern weaving region 102 are taken as one stage of the width cycle, that is, two segments of the first dense weaving region 101 are taken as the two ends of the main-body rib 100, and a segment of the first pattern weaving region 102 is taken as the height side wall of the main-body rib 100. Two segments of the first dense weaving region 101 can be bent relative to the first pattern weaving region 102, that is, after the two segments of the first dense weaving region 101 are connected with the cover cloth 300 and the base cloth 400, respectively, the first pattern weaving region 102 just forms the height side wall of the main-body rib 100. By means of low weaving density, the weight of the main-body rib 100 can be reduced and the ventilation can be improved.

Optionally, the first pattern weaving region 102 and the second pattern weaving region 202 can have a variety of structures. For example, first, no pattern is made, and the weaving region is formed by a grid structure, which can be in a shape of square or diamond; second, weave dense lines to form a unit pattern, the patterns of a unit array, symmetry, and rotation are arranged in an orderly or free way to form a pattern, wherein reinforcing rib lines can be added according to the forces and the patterns; third, as for the regular pattern, each group or several groups can be directly made in the hollow-out design, hollow-out edge is added with dense weaving lines, namely reinforcing rib, and a number of the reinforcement group is no less than a number of patterns. Through the weaving settings of the first pattern weaving region 102 and the second pattern weaving region 202, and through the density of the weaving line, the strength and toughness of the main-body rib 100 and the auxiliary rib 200, and the rib and the pattern region is increased, arbitrary shape hollow-out can be carried out in the appropriate position, reducing the weights of the main-body rib 100 and the auxiliary rib 200, and ensuring the ventilation.

A manufacturing process based on the mentioned rib provided by the present embodiment, including the following steps: weaving the first segment of the first dense weaving region 101, the first pattern weaving region 102, and the second segment of the first dense weaving region 101 in turn according to the preset size, wherein the weaving density of the first pattern weaving region 102 is lower than that of the first dense weaving region 101; weaving the second pattern weaving region 202 and the second dense weaving region 201 in turn according to the preset size, wherein the weaving density of the second pattern weaving region 202 is lower than that of the second dense weaving region 201; making a welded or sewing-fixed connection between the two second pattern weaving regions 202 and the first segment of the first dense weaving region 101 and the second segment of the first dense weaving region 101 in symmetrical positions, respectively.

In the present embodiment, the main-body rib 100 is formed by separately weaving and forming two segments of the first dense weaving region 101 and a segment of the first pattern weaving region 102 which are arranged at intervals, and the auxiliary rib 200 is formed by separately weaving and forming a segment of the second dense weaving region 201 and a segment of the second pattern weaving region 202. The second pattern weaving regions 202 of two auxiliary ribs 200 and the two segments of the first dense weaving region 101 are welded or fixedly connected by sewing in symmetrical positions, that is, the main-body rib 100 and the auxiliary rib 200 are formed by weaving separately, and the ribs are formed by welding or sewing.

An inflatable product is provided in the present embodiment, including a cover cloth 300, a base cloth 400, a side wall 500, and a rib. The side wall 500 is arranged circumferentially along the edge of the cover cloth 300, the side wall 500 is connected with the cover cloth 300 and the base cloth 400, respectively, and an inflatable space for accommodating the rib is formed between the cover cloth 300, the side wall 500, and the base cloth 400. The main-body rib 100 is located between the cover cloth 300 and the base cloth 400. Adhesive layers are arranged at intervals along the surfaces of both sides of the main-body rib 100. The main-body rib 100 is connected, through adhesive layers on both sides, with the cover cloth 300 and the base cloth 400 by a hot melt process respectively. The auxiliary rib 200 is located at a side close to the side wall 500, one end of the auxiliary rib 200 extending out of the main-body rib 100 and the side wall 500 face toward the cover cloth 300 and the base cloth 400 to connect thereto respectively, so as to limit the arc of the side wall 500 through the cover cloth 300 and the base cloth 400.

In the present embodiment, the ribs are applied to the air mattress, wherein the cover cloth 300 and base cloth 400 can be made of TPU-coated fabric, which is suitable for a variety of outdoor environments because of its properties of environmental protection and wear resistance. The ribs are arranged at the position between the cover cloth 300 and the base cloth 400 and close to the side wall 500. As for the quadrilateral structure of the air mattress, four ribs may be arranged, which are corresponding to four side walls 500, respectively. The two opposite sides of the main-body rib 100 are welding-connected with the cover cloth 300 and the base cloth 400 at the local gluing position, respectively, so that the welding point of the air mattress after inflation is depressed downward, whereas other places bulge upward, such that a plurality of patterns are formed on the surface of the inflated mattress, and serve as pillars at the same time. The two ends of the auxiliary rib 200 are connected with the main-body rib 100 and the side wall, respectively, that is, the auxiliary rib 200 can apply an oblique applied force to the side wall, by using the auxiliary rib 200, the arc extension applied force of inflation of the side wall can be transferred to the main-body rib 100 as well as the cover cloth 300 and the base cloth 400 after inflation, so as to limit the arc extension of inflation of the side wall 500. By providing an air valve on the inflated mattress, the technical effect of rapid inflation and deflation and convenient carrying can be realized. Through the practical application of the rib, the rib has the effects of lightweight and ventilation, ensuring more rapid inflation and deflation, thus improving efficiency.

Finally, it should be stated that the above embodiments are only used to illustrate the technical solutions of the present disclosure, not to restrict it; although the present disclosure is described in detail with reference to the aforementioned embodiments, those ordinary skilled in the art should understand that they can still modify the technical solution recited in the aforementioned embodiments, or replace some or all of the technical features with equivalents; these modifications or replacements do not make the essence of the corresponding technical solutions deviate from the scope of the technical solutions of embodiments of the present disclosure.

1. A rib, configured to be installed at a position on an inflatable product close to a side wall, comprising: a main-body rib and an auxiliary rib;
wherein the main-body rib and the auxiliary rib are integrally formed through weaving woven threads, an included angle is formed between the auxiliary rib and the main-body rib, two ends of the main-body rib are configured to be welding-connected with a cover cloth and a base cloth of the inflatable product, respectively, and one end of the auxiliary rib extending out of the main-body rib connected along a length of the side wall, through the auxiliary rib, an arc extension force of inflation of the side wall is transferred to the main-body rib, the cover cloth, and the base cloth, so as to limit an arc of the side wall through the cover cloth and the base cloth.

2. The rib according to claim 1, wherein two auxiliary ribs are provided,
wherein the two auxiliary ribs are located on a same side of the main-body rib, the two auxiliary ribs are arranged symmetrically with a center line of the main-body rib, respectively, the main-body rib is arranged as being of a height corresponding to a height of the side wall, and the two auxiliary ribs are connected along the length of the side wall, so as to make a relatively balanced force on the side wall formed.

3. The rib according to claim 1, wherein the main-body rib comprises a first adhesive layer, and a first dense weaving region and a first pattern weaving region which are integrally formed by weaving, wherein a weaving density of the first pattern weaving region is lower than that of the first dense weaving region; and
the first dense weaving region is provided as two segments, the two segments of the first dense weaving region are clamped at both ends of the first pattern weaving region, the first pattern weaving region is corresponding to the height of the main-body rib, the first adhesive layer is connected to the two segments of the first dense weaving region, and the two segments of the first dense weaving region are welding-connected with the cover cloth and the base cloth through the first adhesive layer, respectively.

4. The rib according to claim 3, wherein the auxiliary rib comprises a second adhesive layer, a second dense weaving region, and a second pattern weaving region, wherein a weaving density of the second pattern weaving region is lower than that of the second dense weaving region; and
the second pattern weaving region is provided by performing extension from interweaving points of the first dense weaving region and the first pattern weaving region, the second pattern weaving region and the first dense weaving region are integrally formed by weaving, the second pattern weaving region and the first pattern weaving region are arranged at an included angle, the second dense weaving region and one end of the second pattern weaving region away from the first dense weaving region are integrally formed by weaving, the second adhesive layer is connected with the second dense weaving region, and the second dense weaving region is welding-connected with the side wall through the second adhesive layer.

5. (canceled)

6. An inflatable product, comprising the cover cloth, the base cloth, the side wall, and the rib according to claim 1;
wherein the side wall is arranged circumferentially along an edge of the cover cloth, the side wall is connected with the cover cloth and the base cloth, respectively, and an inflatable space for accommodating the rib is formed between the cover cloth, the side wall, and the base cloth;
the main-body rib is located between the cover cloth and the base cloth, a first adhesive layer and a second adhesive layer are arranged at intervals along surfaces of both sides of the main-body rib, respectively, and the main-body rib is connected with the cover cloth and the base cloth by a hot melt process through the first and second adhesive layers on both sides;
the auxiliary rib is located at a side close to the side wall, one end of the auxiliary rib extending out of the main-body rib and the side wall face toward both ends of the cover cloth and the base cloth to connect respectively, so as to limit an arc of the side wall through the first adhesive layer and the second adhesive layer.

7. The rib according to claim 2, wherein the main-body rib comprises a first adhesive layer, and a first dense weaving region and a first pattern weaving region which are integrally formed by weaving, wherein a weaving density of the first pattern weaving region is lower than that of the first dense weaving region; and
the first dense weaving region is provided as two segments, the two segments of the first dense weaving region are clamped at both ends of the first pattern weaving region, the first pattern weaving region is corresponding to the height of the main-body rib, the first adhesive layer is connected with the first dense weaving region, and the two segments of the first dense weaving region are welding-connected with the cover cloth and the base cloth through the first adhesive layer, respectively.

8.-10. (canceled)

11. The inflatable product according to claim 6, wherein two auxiliary ribs are provided,
wherein the two auxiliary ribs are located on a same side of the main-body rib, the two auxiliary ribs are arranged symmetrically with a center line of the main-body rib, respectively, the main-body rib is arranged as being of a height corresponding to a height of the side wall, and the two auxiliary ribs are connected along the length of the side wall, so as to make a relatively balanced force on the side wall formed.

12. The inflatable product according to claim 6, wherein the main-body rib comprises a first adhesive layer, and a first dense weaving region and a first pattern weaving region which are integrally formed by weaving, wherein a weaving density of the first pattern weaving region is lower than that of the first dense weaving region; and
the first dense weaving region is provided as two segments, the two segments of the first dense weaving region are clamped at both ends of the first pattern weaving region, the first pattern weaving region is corresponding to the height of the main-body rib, the first adhesive layer is connected to the two segments of the first dense weaving region, and the two segments of the first dense weaving region are welding-connected with the cover cloth and the base cloth through the first adhesive layer, respectively.

13. The inflatable product according to claim 12, wherein the auxiliary rib comprises a second adhesive layer, a second dense weaving region, and a second pattern weaving region, wherein a weaving density of the second pattern weaving region is lower than that of the second dense weaving region; and
the second pattern weaving region is provided by performing extension from interweaving points of the first dense weaving region and the first pattern weaving region, the second pattern weaving region and the first dense weaving region are integrally formed by weaving, the second pattern weaving region and the first pattern weaving region are arranged at an included angle, the second dense weaving region and one end of the second pattern weaving region away from the first dense weaving region are integrally formed by weaving, the second adhesive layer is connected with the second dense weaving region, and the second dense weaving region is welding-connected with the side wall through the second adhesive layer.
